(19) United States
(12) Patent Application Publication
(10) Pub. No.: US 2020/0233251 A1
(43) Pub. Date: Jul. 23, 2020

(54) ARRAY SUBSTRATE AND TOUCH CONTROL DISPLAY PANEL

(71) Applicant: WUHAN CHINA STAR OPTOELECTRONICS TECHNOLOGY CO., LTD., Wuhan, Hubei (CN)

(72) Inventors: Yuejun TANG, Wuhan (CN); Dejiun LI, Wuhan (CN); Baihua LONG, Wuhan (CN)

(73) Assignee: WUHAN CHINA STAR OPTOELECTRONICS TECHNOLOGY CO., LTD., Wuhan, Hubei (CN)

(21) Appl. No.: 16/608,868

(22) PCT Filed: Nov. 15, 2018
(86) PCT No.: PCT/CN2018/115595

§ 371 Date: Oct. 28, 2019

(30) Foreign Application Priority Data
Oct. 10, 2018 (CN) 201811176058.6

(51) Int. Cl. G02F 1/1333; G02F 1/1362; G02F 1/1343; G02F 1/1335; G06F 3/041

(52) U.S. Cl. CPC G02F 1/13338; G02F 1/136286; G02F 1/134309; G02F 2201/123; G02F 1/133512; G06F 3/0412; G02F 1/133514

(57) ABSTRACT

The present disclosure provides an array substrate and a touch control display panel. The touch control display panel is provided with a pixel electrode layer disposed on a wire layer, and has a first pixel electrode, a second pixel electrode, and a third pixel electrode disposed sequentially. The first pixel electrode has at least one first slit, the second pixel electrode has at least one second slit, and the third pixel electrode has at least one third slit. A sum of width of the at least one first slit is greater than a sum of width of the at least one third slit.

### FIELD OF INVENTION

The present invention relates to an array substrate and a touch control display panel, and more particularly, to an array substrate capable of increasing transmittance of an in-cell touch panel fringe field switching (in-cell TP-FFS) liquid crystal display and a touch control display panel using the array substrate.

### BACKGROUND OF INVENTION

An in-cell touch panel fringe field switching (in-cell TP-FFS) liquid crystal display having touch control functions embedded therein has the advantages of high integration, light weight, and thinness.

The in-cell TP-FFS in the FFS liquid crystal display uses common electrodes as sensing electrodes and touch wires are formed under the common electrodes additionally. The touch wires allow a metal wiring layer to be produced on data lines and below the common electrodes. A disadvantage of this way is that one or two mask process is needed and not conductive to cost reduction. Therefore, now another in-cell touch control structure is provided with touch wires at a side parallel to the data lines during manufacturing the data lines, that is, the touch wires are disposed between RG sub-pixels and parallel to the data lines.

However, the data lines in the in-cell touch control structure parallel to the touch wires occupy a broader shading area so that a color filter substrate disposed thereon also needs a wider black matrix to cover this shading area, and this makes an aperture ratio of RGB sub-pixels decreased and transmittance also lowered.

It is therefore necessary to provide an array substrate and a touch control display panel in order to solve the problems existing in the conventional technology as described above.

### SUMMARY OF INVENTION

In view of this, the primary object of the present invention is to provide an array substrate having a pixel electrode having sub-pixels with touch wires on both sides that are adjusted to reduce or increase the line width, the pitch, and the ITO interval, thereby improving the transmittance of the touch control display panel in order to reduce power consumption.

Another embodiment of the present invention provides a touch control display panel including the above array substrate, a liquid crystal layer, and a color filter substrate. It is characterized that the distances between the color resist layer of the color filter substrate are different. The above array substrate is applicable because the two color resists far apart are blocked by black color resists and thus the two color resists having larger distance from each other can be disposed correspondingly to the pixel electrode with larger slit width, or provided with a larger interval between the electrode and the black color resist to improve the liquid crystal efficiency of the sub-pixels and thereby increasing the transmittance of the display panel.

To achieve above objects, one embodiment of the present invention provides an array substrate, comprising: a substrate; and an array structural layer disposed on the substrate, wherein the array structural layer comprises: a wiring layer including a first data line, a second data line, a third data line, and a touch wire; and a pixel electrode layer disposed on the wiring layer, including a first pixel electrode, a second pixel electrode, and a third pixel electrode disposed sequentially, wherein the first pixel electrode has at least one first slit, the second pixel electrode has at least one second slit, and the third pixel electrode has at least one third slit; wherein the touch wire and the second data line are disposed between the first data line and the third data line, and a first distance between the touch wire and the first data line is greater than a second distance between the touch wire and the second data line; and wherein the first pixel electrode is disposed at a first region between the touch wire and the first data line on the wiring layer, and a sum of width of the at least one first slit is greater than a sum of width of the at least one third slit; and wherein the second pixel electrode is disposed at a second region between the touch wire and the third data line on the wiring layer, and a sum of width of the at least one second slit is greater than a sum of width of the at least one third slit.

In one embodiment of the present invention, the first pixel electrode has at least one first electrode portion, the third pixel electrode has at least one third electrode portion, and a sum of width of the at least one first electrode portion is greater than a sum of width of the at least one third electrode portion.

In one embodiment of the present invention, the first pixel electrode has one of the first slits, and the third pixel electrode has one of the third slits.

In one embodiment of the present invention, a distance between the first pixel electrode and the second pixel electrode is greater than or equal to a distance between the second pixel electrode and the third pixel electrode.

In one embodiment of the present invention, the first pixel electrode has two of the first slits, the second pixel electrode has two of the second slits, and the third pixel electrode has one of the third slits, a distance between the first pixel electrode and the second pixel electrode is greater than a distance between the second pixel electrode and the third pixel electrode.

To achieve above objects, another embodiment of the present invention provides an array substrate, comprising: a substrate; and an array structural layer disposed on the substrate, comprising: a wiring layer including a first data line, a second data line, a third data line, and a touch wire; and a pixel electrode layer disposed on the wiring layer, including a first pixel electrode, a second pixel electrode, and a third pixel electrode disposed sequentially, wherein the first pixel electrode has at least one first slit, the second pixel electrode has at least one second slit, and the third pixel electrode has at least one third slit; wherein the touch wire and the second data line are disposed between the first data line and the third data line, and a first distance between the touch wire and the first data line is greater than a second distance between the touch wire and the second data line; and wherein the first pixel electrode is disposed at a first region between the touch wire and the first data line on the wiring layer, and a sum of width of the at least one first slit is greater than a sum of width of the at least one third slit.

In one embodiment of the present invention, the second pixel electrode is disposed at a second region between the touch wire and the third data line on the wiring layer, and a sum of width of the at least one second slit is greater than a sum of width of the at least one third slit.

In one embodiment of the present invention, the first pixel electrode has at least one first electrode portion, and the third pixel electrode has at least one third electrode portion, and a sum of width of the at least one first electrode portion is greater than a sum of width of the at least one third electrode portion.

In one embodiment of the present invention, the first pixel electrode has one of the first slits, and the third pixel electrode has one of the third slits.

In one embodiment of the present invention, a distance between the first pixel electrode and the second pixel electrode is greater than or equal to a distance between the second pixel electrode and the third pixel electrode.

In one embodiment of the present invention, the first pixel electrode has two of the first slits, and the third pixel electrode has one of the third slits.

In one embodiment of the present invention, a distance between the first pixel electrode and the second pixel electrode is greater than a distance between the second pixel electrode and the third pixel electrode.

In one embodiment of the present invention, the first pixel electrode has two of the first slits, the second pixel electrode has two of the second slits, and the third pixel electrode has one of the third slits.

In one embodiment of the present invention, a distance between the first pixel electrode and the second pixel electrode is greater than a distance between the second pixel electrode and the third pixel electrode.

To achieve above objects, another embodiment of the present invention provides a touch control display panel, comprising: the abovementioned array substrate; a color filter substrate; and a liquid crystal layer disposed between the color filter substrate and the array substrate; wherein the color filter substrate comprises: a first color resist disposed correspondingly to the first pixel electrode; a second color resist disposed correspondingly to the second pixel electrode; a third color resist disposed correspondingly to the third pixel electrode; and at least one black color resist disposed between the first color resist, the second color resist, and the third color resist; wherein a distance between the first color resist and the second color resist is greater than a distance between the second color resist and the third color resist.

In one embodiment of the present invention, the first color resist is a red color resist, the second color resist is a green color resist, and the third color resist is a blue color resist.

In one embodiment of the present invention, the at least one black color resist includes a first black color resist disposed between the first color resist and the second color resist; a second black color resist disposed between the second color resist and the third color resist; and a width of the first black color resist is greater than a width of the second black color resist.

In one embodiment of the present invention, a first interval between a left side of the first black color resist and the first pixel electrode is greater than 0 micrometer, and the first interval is also provided between a right side of the first black color resist and the second pixel electrode.

In one embodiment of the present invention, a second interval is disposed between a left side of the second black color resist and the second pixel electrode, and the second interval is also provided between a right side of the second black color resist and the third pixel electrode.

In one embodiment of the present invention, the first interval is less than or equal to the second interval.

### BRIEF DESCRIPTION OF DRAWINGS

FIG. 1 is a schematic view of a touch control display panel according to one embodiment of the present invention.

FIG. 2 is a schematic view of a touch control display panel according to another embodiment of the present invention.

FIG. 3 is a schematic view of a touch control display panel according to an embodiment of the present invention.

### DETAILED DESCRIPTION OF PREFERRED EMBODIMENTS

The detailed description of the following embodiments is used for exemplifying the specific embodiments of the present invention by referring to the accompany drawings. Furthermore, directional terms described by the present invention, such as upper, lower, front, back, left, right, inner, outer, side, etc., are only directions by referring to the accompanying drawings, and thus the directional terms are used to describe and understand the present invention, but the present invention is not limited thereto.

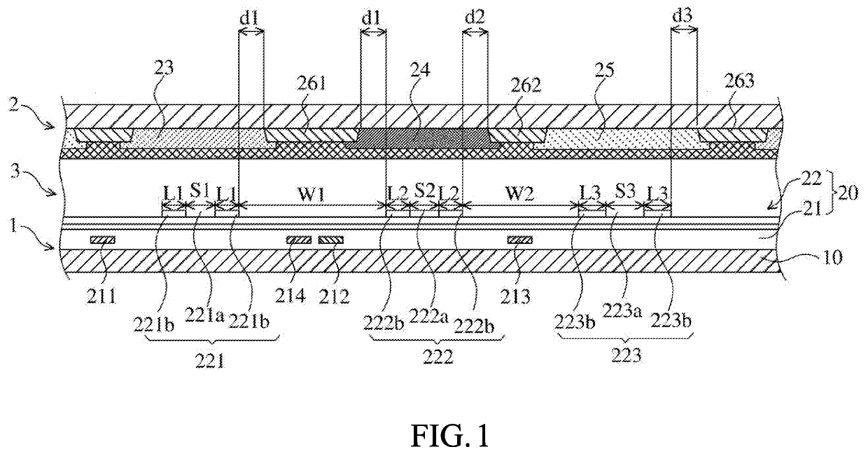

Referring to FIG. 1, which shows a schematic view of a touch control display panel 100 according to one embodiment of the present invention. The touch control display panel 100 includes an array substrate 1, a color filter substrate 2, and a liquid crystal layer 3. The liquid crystal layer 3 is disposed between the array substrate 1 and the color filter substrate 2. The liquid crystal layer 3 can be formed by general liquid crystals such as nematic liquid crystals or cholesterol liquid crystals, but they are not limited thereto. The types of the liquid crystals used herein are not limited. In addition, the embodiments of the present invention describe only the components and configurations involved, and do not limit the addition of other functional components.

The array substrate 1 comprises a substrate 10 and an array structural layer 20. The array structural layer 20 is disposed on the substrate 10, and includes a wiring layer 21 and a pixel electrode layer 22. The pixel electrode layer 22 is disposed on the wiring layer 21.

The wiring layer 21 comprises a first data lines 211, a second data line 212, a third data line 213, and a touch wire 214. The wiring layer 211 can also be provided with other wires and material layers, and it is not limited to the abovementioned data lines.

The pixel electrode layer 22 has a first pixel electrode 221, a second pixel electrode 222, and a third pixel electrode 223 sequentially disposed. The first pixel electrode 221 has a first slit 221a; the second pixel electrode 222 has a second slit 222a; the third pixel electrode 223 has a third slit 223a.

The touch wire 214 and the second data line 212 are both disposed between the first data line 211 and the third data line 213. Preferably, a distance between the touch wire 214 and the second data line 212 is shorter than a distance between the first data line 211 and the third data line 213. Preferably, the touch wire 214 is disposed at a left or right side of the second data line 212, and a first distance between the touch wire 214 and the first line 211 is greater than a second distance between the touch wire 214 and the second data line 212.

As shown in FIG. 1, the first pixel electrode 221 is disposed at a first region between the touch wire 214 and the first data line 211 on the wiring layer 21, and a width S1 of the first slit 221a is greater than a width S3 of the third slit 223a. Preferably, the second pixel electrode 222 is disposed at a second region between the touch wire 214 and the third data line 213 on the wiring layer 21, and a width S2 of the at least one second slit 222a is greater than a width S3 of the at least one third slit 223a. Preferably, a distance W1 between the first pixel electrode 221 and the second pixel electrode 222 is greater than or equal to a distance W2 between the second pixel electrode 222 and the third pixel electrode 223.

In this embodiment, the first pixel electrode 221 has two of first electrode portions 221b, the second pixel electrode 222 has two of second electrode portions 222b, and the third pixel electrode 223 has two of third electrode portions 223b. The first electrode portions 221b have a width L1 equal to a width L3 of the third electrode portions 223b. A width L2 of the second electrode portions 222b is equal to the width L1 of the first electrode portions 221b. That is, a sum of width 2×L1 of two of the first electrode portions 221b is equal to a sum of width 2×L3 of the third electrode portions 223b; a sum of width 2×L2 of two of the second electrode portions 222b is also equal to a sum of width 2×L3 of the third electrode portions 223b.

Furthermore, the color filter substrate 2 comprises a first color resist 23 disposed correspondingly to the first pixel electrode 221; a second color resist 24 disposed correspondingly to the second pixel electrode 222; a third color resist 25 disposed correspondingly to the third pixel electrode 223; and a first black color resist 261 and a second black color resist 262 disposed between the first color resist 23, the second color resist 24 and the third color resist 25; a third black color resist 263 is disposed between the third color resist 25 and next color resist (not shown).

A distance between the first color resist 23 and the second color resist 24 is greater than a distance between the second color resist 24 and the third color resist 25. Therefore, for shading the distance between the first color resist 23 and the second color resist 24, a width of the first black color resist 261 would be greater than a width of the second black color resist 262.

Preferably, the first color resist 23 is a red color resist, the second color resist 24 is a green color resist, and the third color resist 25 is a blue color resist. In this embodiment, an interval d1 between a left side of the first black color resist 261 and the first pixel electrode 221 is greater than 0 micrometer, and the interval d1 is also provided between a right side of the first black color resist 261 and the second pixel electrode 222. Similarly, an interval d2 is disposed between a left side of the second black color resist 262 and the second pixel electrode 222, and the interval d2 is also provided between a right side of the second black color resist 262 and the third pixel electrode 223. An interval d3 is provided between a left side of the third black color resist 263 and the third pixel electrode 223. Preferably, when d1=d2=d3, the region corresponding to the first pixel electrode 221 or the second pixel electrode 222 has a liquid crystal efficiency greater than that of the region corresponding to the third pixel electrode 223. Preferably, when d1<d2=d3 and W1 is greater than or equal to W2, the region corresponding to the first pixel electrode 221 or the second pixel electrode 222 has a liquid crystal efficiency greater than that of the region corresponding to the third pixel electrode 223. In this embodiment, the influence of the first color resist 23, the second color resist 24, and the third color resist 25 on the liquid crystal efficiency can be ignored, and it can only be considered that one or both of the first pixel electrode 221 and the second pixel electrode 222 has transmittance higher than that of the third pixel electrode 223. That is, the transmittance of a sub-pixel excluding color resists can characterize the liquid crystal efficiency of a display panel.

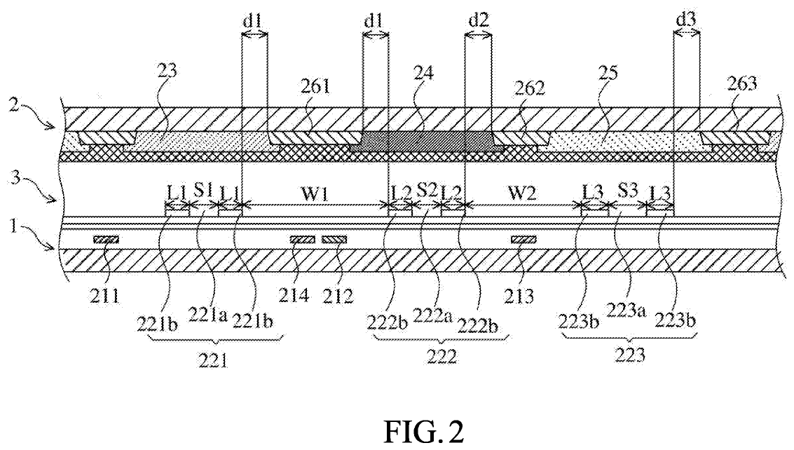

Referring to FIG. 2, which shows a schematic view of a touch control display panel according to another embodiment of the present invention. Except for the differences described below, the arrangement of the remaining components is the same as that of the above embodiment, and therefore will not be further described.

In this embodiment, a width L1 of the first electrode portion 221b is greater than a width L3 of the third electrode portion 223b. A width L2 of the second electrode portion 222b is equal to a width L1 of the first electrode portion 221b. That is, a sum of width 2×L1 of two of the first electrode portions 221b is greater than a sum of width 2×L3 of the third electrode portion 223b. A sum of width 2×L2 of two of the second electrode portions 222b is also greater than a sum of width 2×L3 of two of the third electrode portions 223b. Preferably, a distance W1 between the first pixel electrode 221 and the second pixel electrode 222 is greater than a distance W2 between the second pixel electrode 222 and the third pixel electrode 223.

In this embodiment, an interval d1 greater than 0 micrometer is provided between a side of the first pixel electrode 221 near the second pixel electrode 222 and the first black resist 261.

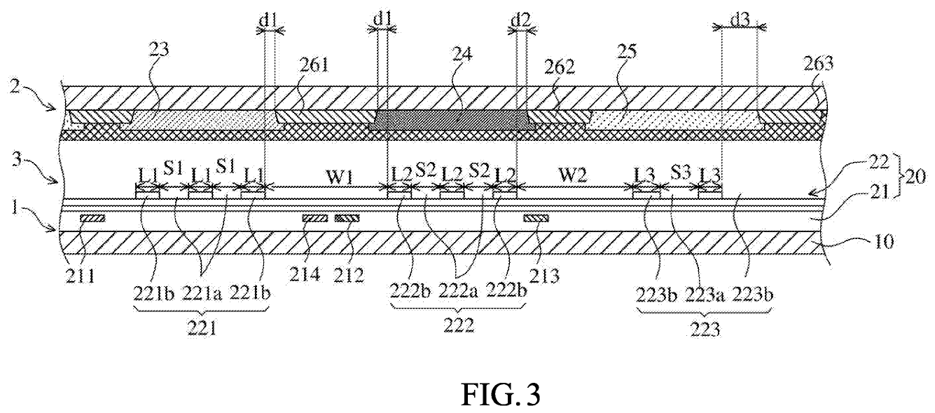

Referring to FIG. 3, which shows a schematic view of a touch control display panel 100 according to a further embodiment of the present invention. Except for the differences described below, the arrangement of the remaining components is the same as that of the above embodiment, and therefore will not be further described.

As shown in FIG. 3, the first pixel electrode 221 is disposed at a first region between the touch wire 214 and the first data line 211 on the wiring layer 21, and a width S1 of the first slit 221a is less than a width S3 of the third slit 223a. Preferably, the second pixel electrode 222 is disposed at a second region between the touch wire 214 and the third data line 213 on the wiring layer 21. Preferably, a distance W1 between the first pixel electrode 221 and the second pixel electrode 222 is greater than or equal to a distance W2 between the second pixel electrode 222 and the third pixel electrode 223.

In this embodiment, the first pixel electrode 221 has three of the first electrode portions 221b, the second pixel electrode 222 has three of the second electrode portions 222b, and the third pixel electrode 223 has two of the third electrode portions 223b. The first electrode portion 221b has a width L1 less than a width L3 of the third electrode portion 223b. a width L2 of the second electrode portion 222b is equal to the width L1 of the first electrode portion 221b. Preferably, a sum of width 3×L1 of three of the first electrode portions 221b is greater than or equal to a sum of width 2×L3 of the third electrode portions 223b. Preferably, a sum of width 3×L2 of three of the second electrode portions 222b is greater than or equal to the sum of width 2×L3 of the third electrode portions 223b.

In this embodiment, the first pixel electrode 221 has two of the first slits 221a, and the third pixel electrode 223 has one of the third slits 223a. The total width 2×S1 of the two of the first slits 221a is greater than a width of the third slit S3. Although it is not shown, if the third pixel electrode 223 also has two of the third slits 223a, the total width 2×S1 of the two of the first slits 221a is still greater than a total width 2×S3 of two of the third slits S3.

In this embodiment, a distance W1 between the first pixel electrode 221 and the second pixel electrode 222 is greater than or equal to a distance W2 between the second pixel electrode 222 and the third pixel electrode 223. Preferably, an interval d1 between a left side of the first black color resist 261 and the first pixel electrode 221 is greater than 0 micrometer, and the interval d1 is also provided between a right side of the first black color resist 261 and the second pixel electrode 222. Similarly, an interval d2 is disposed between a left side of the second black color resist 262 and the second pixel electrode 222, and the interval d2 is also provided between a right side of the second black color resist 262 and the third pixel electrode 223; an interval d3 is provided between a left side of the third black color resist 263 and the third pixel electrode 223. Preferably, when d1=d2=d3, the region corresponding to the first pixel electrode 221 or the second pixel electrode 222 has liquid crystal efficiency greater than that of the region corresponding to the third pixel electrode 223. Preferably, when d1<d2=d3 and W1 is greater than or equal to W2, the region corresponding to the first pixel electrode 221 or the second pixel electrode 222 has liquid crystal efficiency greater than that of the region corresponding to the third pixel electrode 223.

The present application has been described by the above related embodiments, but the above embodiments are merely examples for implementing the present application. It must be noted that the disclosed embodiments do not limit the scope of the present application. Rather, modifications and equivalent arrangements included in the spirit and scope of the claims are intended to be included within the scope of the present application.

What is claimed is:

1. An array substrate, comprising:
a substrate; and
an array structural layer disposed on the substrate, wherein the array structural layer comprises:
a wiring layer including a first data line, a second data line, a third data line, and a touch wire; and
a pixel electrode layer disposed on the wiring layer, including a first pixel electrode, a second pixel electrode, and a third pixel electrode disposed sequentially, wherein the first pixel electrode has at least one first slit, the second pixel electrode has at least one second slit, and the third pixel electrode has at least one third slit;
wherein the touch wire and the second data line are disposed between the first data line and the third data line, and a first distance between the touch wire and the first data line is greater than a second distance between the touch wire and the second data line; and
wherein the first pixel electrode is disposed at a first region between the touch wire and the first data line on the wiring layer, and a sum of width of the at least one first slit is greater than a sum of width of the at least one third slit; and
wherein the second pixel electrode is disposed at a second region between the touch wire and the third data line on the wiring layer, and a sum of width of the at least one second slit is greater than a sum of width of the at least one third slit.

2. The array substrate according to claim 1, wherein the first pixel electrode has at least one first electrode portion, the third pixel electrode has at least one third electrode portion, and a sum of width of the at least one first electrode portion is greater than a sum of width of the at least one third electrode portion.

3. The array substrate according to claim 1, wherein the first pixel electrode has one of the first slits, and the third pixel electrode has one of the third slits.

4. The array substrate according to claim 3, wherein a distance between the first pixel electrode and the second pixel electrode is greater than or equal to a distance between the second pixel electrode and the third pixel electrode.

5. The array substrate according to claim 1, wherein the first pixel electrode has two of the first slits, the second pixel electrode has two of the second slits, and the third pixel electrode has one of the third slits, a distance between the first pixel electrode and the second pixel electrode is greater than a distance between the second pixel electrode and the third pixel electrode.

6. An array substrate, comprising:
a substrate; and
an array structural layer disposed on the substrate, comprising:
a wiring layer including a first data line, a second data line, a third data line, and a touch wire; and
a pixel electrode layer disposed on the wiring layer, including a first pixel electrode, a second pixel electrode, and a third pixel electrode disposed sequentially, wherein the first pixel electrode has at least one first slit, the second pixel electrode has at least one second slit, and the third pixel electrode has at least one third slit;
wherein the touch wire and the second data line are disposed between the first data line and the third data line, and a first distance between the touch wire and the first data line is greater than a second distance between the touch wire and the second data line; and
wherein the first pixel electrode is disposed at a first region between the touch wire and the first data line on the wiring layer, and a sum of width of the at least one first slit is greater than a sum of width of the at least one third slit.

7. The array substrate according to claim 6, wherein the second pixel electrode is disposed at a second region between the touch wire and the third data line on the wiring layer, and a sum of width of the at least one second slit is greater than a sum of width of the at least one third slit.

8. The array substrate according to claim 6, wherein the first pixel electrode has at least one first electrode portion, and the third pixel electrode has at least one third electrode portion, and a sum of width of the at least one first electrode portion is greater than a sum of width of the at least one third electrode portion.

9. The array substrate according to claim 6, wherein the first pixel electrode has one of the first slits, and the third pixel electrode has one of the third slits.

10. The array substrate according to claim 9, wherein a distance between the first pixel electrode and the second pixel electrode is greater than or equal to a distance between the second pixel electrode and the third pixel electrode.

11. The array substrate according to claim 6, wherein the first pixel electrode has two of the first slits, and the third pixel electrode has one of the third slits.

12. The array substrate according to claim 11, wherein a distance between the first pixel electrode and the second pixel electrode is greater than a distance between the second pixel electrode and the third pixel electrode.

13. The array substrate according to claim 6, wherein the first pixel electrode has two of the first slits, the second pixel electrode has two of the second slits, and the third pixel electrode has one of the third slits.

14. The array substrate according to claim 13, wherein a distance between the first pixel electrode and the second pixel electrode is greater than a distance between the second pixel electrode and the third pixel electrode.

15. A touch control display panel, comprising:
the array substrate according to claim 6;
a color filter substrate; and
a liquid crystal layer disposed between the color filter substrate and the array substrate;
wherein the color filter substrate comprises:
a first color resist disposed correspondingly to the first pixel electrode;
a second color resist disposed correspondingly to the second pixel electrode;
a third color resist disposed correspondingly to the third pixel electrode; and
at least one black color resist disposed between the first color resist, the second color resist, and the third color resist;
wherein a distance between the first color resist and the second color resist is greater than a distance between the second color resist and the third color resist.

16. The touch control display panel according to claim 15, wherein the first color resist is a red color resist, the second color resist is a green color resist, and the third color resist is a blue color resist.

17. The touch control display panel according to claim 15, wherein the at least one black color resist includes a first black color resist disposed between the first color resist and the second color resist; a second black color resist disposed between the second color resist and the third color resist; and a width of the first black color resist is greater than a width of the second black color resist.

18. The touch control display panel according to claim 15, wherein a first interval between a left side of the first black color resist and the first pixel electrode is greater than 0 micrometer, and the first interval is also provided between a right side of the first black color resist and the second pixel electrode.

19. The touch control display panel according to claim 18, wherein a second interval is disposed between a left side of the second black color resist and the second pixel electrode, and the second interval is also provided between a right side of the second black color resist and the third pixel electrode.

20. The touch control display panel according to claim 19, wherein the first interval is less than or equal to the second interval.
